(19) United States
(12) Patent Application Publication
(10) Pub. No.: US 2019/0066671 A1
(43) Pub. Date: Feb. 28, 2019

(54) FAR-FIELD SPEECH AWAKING METHOD, DEVICE AND TERMINAL DEVICE

(71) Applicant: BAIDU ONLINE NETWORK TECHNOLOGY (BEIJING) CO., LTD., Beijing (CN)

(72) Inventor: Lei GENG, Beijing (CN)

(21) Appl. No.: 16/031,751

(22) Filed: Jul. 10, 2018

(30) Foreign Application Priority Data
Aug. 22, 2017 (CN) 201710725764.0

(51) Int. Cl. G10L 15/22; G10L 15/30; G10L 25/78; G10L 21/0208

(52) U.S. Cl. CPC G10L 15/22; G10L 15/30; G10L 2015/088; G10L 21/0208; G10L 25/78

(57) ABSTRACT

The present disclosure provides a far-field speech awaking method, a device and a terminal device. The far-field speech awaking method includes: under a far-field speech awaking state, detecting a sound signal obtained by a microphone array under; when an awaking word is detected in the sound signal, sending the sound signal to an online speech awaking engine; receiving confirmation information sent from the online speech awaking engine, wherein the confirmation information is sent after the online speech awaking engine identifies the awaking word in the sound signal; and starting a speech assistant to perform speech recognition.

### CROSS-REFERENCE TO RELATED APPLICATION

This application claims priority to and benefits of Chinese Patent Application Serial No. 201710725764.0, filed with the State Intellectual Property Office of P. R. China on Aug. 22, 2017, the entire content of which is incorporated herein by reference.

### FIELD

The present disclosure relates to a speech awaking technology field, and more particularly to a far-field speech awaking method, device and a terminal device.

### BACKGROUND

In the far-field speech awakening technology in the related art, a microphone array is used to pick up speaker's voice, and after the speaker's voice is performed an echo cancellation algorithm, the speaker's voice is input to an offline speech awaking engine of a hardware terminal. Far-field speech recognition is started after an awaking word is recognized.

### SUMMARY

Embodiments of the present disclosure seek to solve at least one of the problems existing in the related art to at least some extent.

For this, embodiments of a first aspect of the present disclosure provide a far-field speech awaking method is provided, including: under a far-field speech awaking state, detecting a sound signal obtained by a microphone array; when an awaking word is detected in the sound signal, sending the sound signal to an online speech awaking engine; receiving confirmation information sent from the online speech awaking engine, in which the confirmation information is sent after the online speech awaking engine identifies the awaking word in the sound signal; and starting a speech assistant to perform speech recognition.

Embodiments of a second aspect of the present disclosure provide a far-field speech awaking device, including: a detection module, configured to, under a far-field speech awaking state, detect a sound signal obtained by a microphone array; a sending module, configured to send the sound signal to an online speech awaking engine when the detection module detects an awaking word in the sound signal; a receiving module, configured to receive confirmation information sent from the online speech awaking engine, in which the confirmation information is sent after the online speech awaking engine identifies the awaking word in the sound signal; and a starting module, configured to start a speech assistant to perform speech recognition.

Embodiments of a third aspect of the present disclosure provide a terminal device, including a memory, a processor and a computer program executable on the processor and stored on the memory, when executed by the processor, causing the processor to implement the above-mentioned method.

Embodiments of a fourth aspect of the present disclosure provide a non-transitory computer readable storage medium, having a computer program thereon. The computer program is configured to implement the above-mentioned method when executed by a processor.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a flow chart of a far-field speech awaking method according to an embodiment of the present disclosure.

FIG. 2 is a flow chart of a far-field speech awaking method according to another embodiment of the present disclosure.

FIG. 3 is a flow chart of a far-field speech awaking method according to yet another embodiment of the present disclosure.

FIG. 4 is a block diagram of a far-field speech awaking device according to an embodiment of the present disclosure.

FIG. 5 is a schematic diagram of a terminal device according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

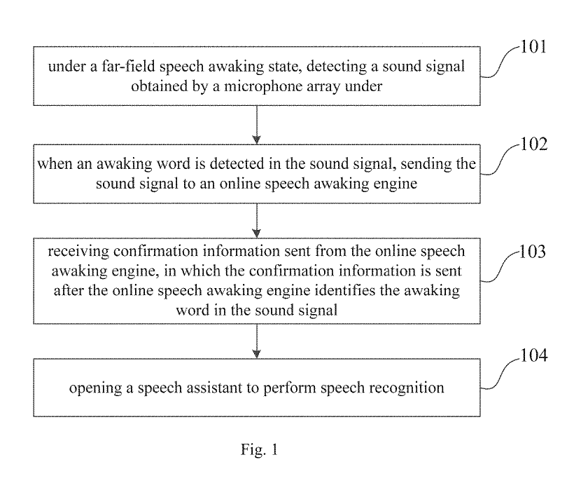

FIG. 1 is a flow chart of a far-field speech awaking method according to an embodiment of the present disclosure. As illustrated in FIG. 1, the far-field speech awaking method may include follows.

At block 101, under a far-field speech awaking state, a sound signal obtained by a microphone array is detected.

In some embodiments of the present disclosure, when an offline speech awaking engine is under a far-field speech awaking state, the offline speech awaking engine detects the sound signal obtained by the microphone array.

The far-field speech awaking state is a state in which the offline speech awaking engine is turned on after the power is turned on.

At block 102, when an awaking word is detected in the sound signal, the sound signal is sent to an online speech awaking engine.

In some embodiments of the present disclosure, when the awaking word is detected in the sound signal, the offline speech awaking engine sends the sound signal obtained by the microphone array to the online speech awaking engine.

In detail, after receiving the sound signal obtained by the microphone array, the offline speech awaking engine may cache the above sound signal obtained by the microphone array. The step of caching the above sound signal obtained by the microphone array and the step at block 101 may be performed in parallel or may be performed in sequence, which is not limited in embodiments of the present disclosure. Then, after the awaking word is detected in the sound signal, the offline speech awaking engine may send the cached sound signal to the online speech awaking engine.

At block 103, confirmation information sent from the online speech awaking engine is received. The confirmation information is sent after the online speech awaking engine identifies the awaking word in the sound signal.

Calculation capability of the online speech recognition (i.e., the cloud speech recognition) is very powerful, therefore, an acoustic model of the online recognition is more complex, with better performance, thus, by using a second confirmation via the online speech awaking after recognizing the awaking word using offline speech awaking, false awaking rate is reduced greatly, and user experience is improved.

At block 104, a speech assistant is started to perform speech recognition.

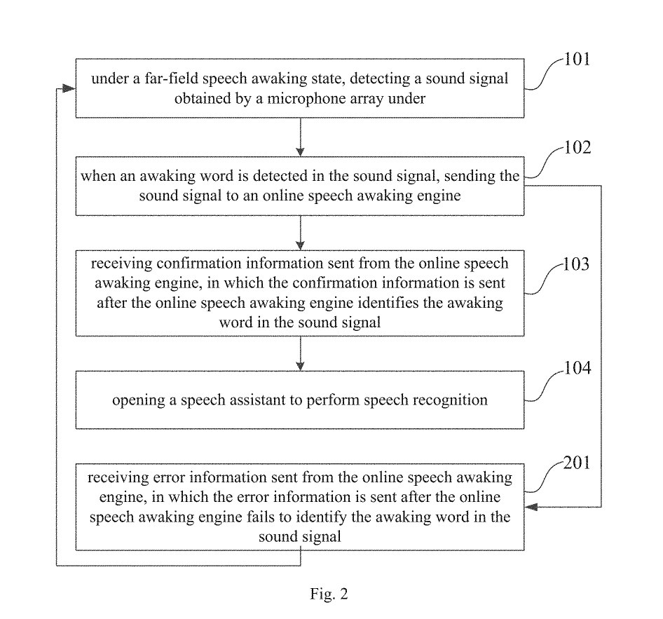

FIG. 2 is a flow chart of a far-field speech awaking method according to another embodiment of the present disclosure. As illustrated in FIG. 2, after the step at block 102 of the far-field speech awaking method illustrated in FIG. 1, the method may further include follows.

At block 201, error information sent from the online speech awaking engine is received, in which the error information is sent after the online speech awaking engine fails to identify the awaking word in the sound signal.

Then it is returned to perform the step at block 101.

In embodiments of the present disclosure, if the online speech awaking engine fails to identify the awaking word in the sound signal, the online speech awaking engine returns the error information to the offline speech awaking engine. After receiving the error information sent from the online speech awaking engine, the offline speech awaking engine returns to perform the step at block 101 to detect the sound signal obtained by the microphone array rather than starts the speech assistant.

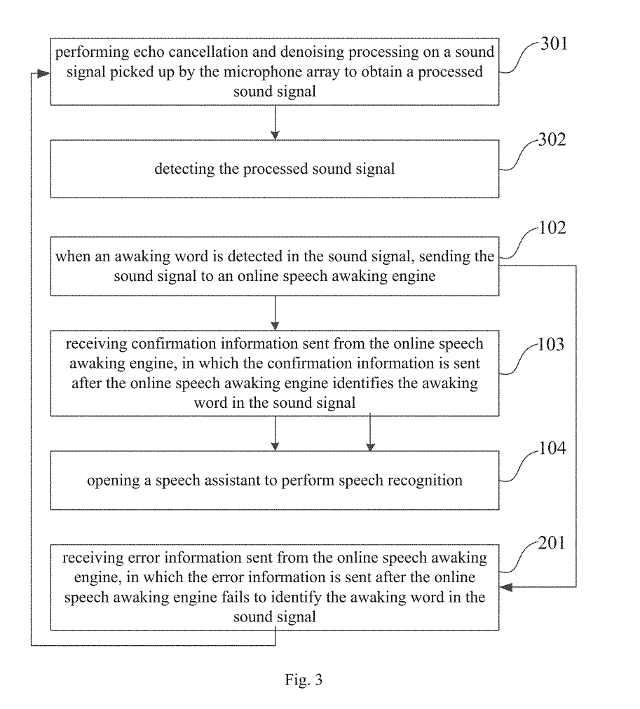

FIG. 3 is a flow chart of a far-field speech awaking method according to yet another embodiment of the present disclosure. As illustrated in FIG. 3, the step at block 101 of the far-field speech awaking method illustrated in FIG. 1 may further include follows.

At block 301, echo cancellation and denoising processing are performed on a sound signal picked up by the microphone array to obtain a processed sound signal.

At block 302, the processed sound signal is detected.

In some embodiments of the present disclosure, after the microphone array picks up the sound signal, firstly the echo cancellation and the denoising processing are performed on the sound signal picked up by the microphone array. For example, acoustic echo cancellation (AEC for short) algorithm is used to perform the echo cancellation and the denoising processing on the sound signal picked up by the microphone array. Then, the offline speech awaking engine detects the processed sound signal.

With the far-field speech awaking method according to embodiments of the present disclosure, under the far-field speech awaking state, the sound signal obtained by a microphone array is detected, when the awaking word is detected in the sound signal, the sound signal is sent to the online speech awaking engine, after the confirmation information sent from the online speech awaking engine is received, the speech assistant is started to perform speech recognition. The confirmation information is sent after the online speech awaking engine identifies the awaking word in the sound signal, therefore, it realizes a second confirmation via the online speech awaking after recognizing the awaking word using offline speech awaking, thus reducing false awaking rate greatly, and improving user experience.

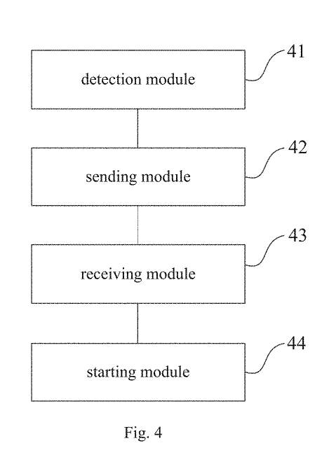

FIG. 4 is a block diagram of a far-field speech awaking device according to an embodiment of the present disclosure. The far-field speech awaking device in this embodiment of the present disclosure may be taken as the offline speech awaking engine to implement the far-field speech awaking method according to embodiments of the present disclosure. As illustrated in FIG. 4, the far-field speech awaking device may include a detection module 41, a sending module 42, a receiving module 43, and a starting module 44.

The detection module 41 is configured to, under a far-field speech awaking state, detect a sound signal obtained by a microphone array. In some embodiments of the present disclosure, under a far-field speech awaking state, the detection module 41 detects the sound signal obtained by the microphone array.

The far-field speech awaking state is a state in which the offline speech awaking engine is turned on after the power is turned on.

The sending module 42 is configured to send the sound signal to an online speech awaking engine when the detection module 41 detects an awaking word in the sound signal. In some embodiments of the present disclosure, when the awaking word is detected in the sound signal, the sending module 42 sends the sound signal obtained by the microphone array to the online speech awaking engine.

In detail, after receiving the sound signal obtained by the microphone array, the offline speech awaking engine may cache the above sound signal obtained by the microphone array. The step of caching the above sound signal obtained by the microphone array and the step that the detection module 41 detects the awaking word in the sound signal may be performed in parallel or may be performed in sequence, which is not limited in embodiments of the present disclosure. Then, after the detection module 41 detects the awaking word in the sound signal, the sending module 42 may send the cached sound signal to the online speech awaking engine.

The receiving module 43 is configured to receive confirmation information sent from the online speech awaking engine, in which the confirmation information is sent after the online speech awaking engine identifies the awaking word in the sound signal. Calculation capability of the online speech recognition (i.e., the cloud speech recognition) is very powerful, therefore, an acoustic model of the online recognition is more complex, with better performance, thus, by using a second confirmation via the online speech awaking after recognizing the awaking word using offline speech awaking, false awaking rate is reduced greatly, and user experience is improved.

The starting module 44 is configured to start a speech assistant to perform speech recognition.

Further, the receiving module 43 is configured to receive error information sent from the online speech awaking engine after the sending module 42 sends the sound signal to the online speech awaking engine. The error information is sent after the online speech awaking engine fails to identify the awaking word in the sound signal.

In embodiments of the present disclosure, if the online speech awaking engine fails to identify the awaking word in the sound signal, the online speech awaking engine returns the error information to the offline speech awaking engine. After the receiving module 43 receives the error information sent from the online speech awaking engine, the offline speech awaking engine does not start the speech assistant, while the detection module 41 continues to detect the sound signal obtained by the microphone array.

In some embodiments of the present disclosure, the detection module 41 is configured to perform echo cancellation and denoising processing on a sound signal picked up by the microphone array to obtain a processed sound signal, and to detect the processed sound signal.

In some embodiments of the present disclosure, after the microphone array picks up the sound signal, the detection module 41 firstly performs the echo cancellation and the denoising processing on the sound signal picked up by the microphone array. For example, acoustic echo cancellation (AEC for short) algorithm is used to perform the echo cancellation and the denoising processing on the sound signal picked up by the microphone array. Then, the detection module 41 detects the processed sound signal.

With the far-field speech awaking device according to embodiments of the present disclosure, under the far-field speech awaking state, the detection module 41 detects the sound signal obtained by a microphone array, when the awaking word is detected in the sound signal, the sending module 42 sends the sound signal to the online speech awaking engine, after the receiving module 43 receives the confirmation information sent from the online speech awaking engine, the starting module 44 starts the speech assistant to perform speech recognition. The confirmation information is sent after the online speech awaking engine identifies the awaking word in the sound signal, therefore, it realizes a second confirmation via the online speech awaking after recognizing the awaking word using offline speech awaking, thus reducing false awaking rate greatly, and improving user experience.

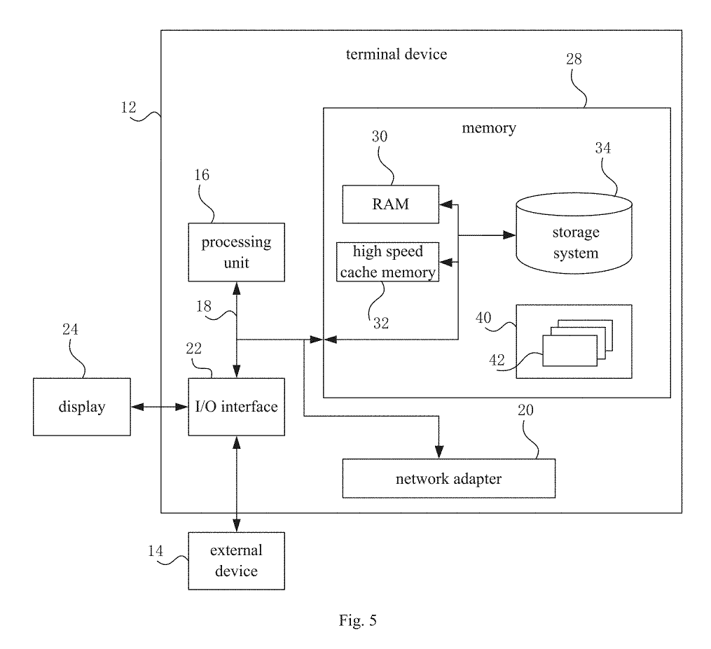

FIG. 5 is a schematic diagram of a terminal device according to an embodiment of the present disclosure. As illustrated in FIG. 5, the above terminal device may include a memory, a processor and a computer program executable on the processor and stored on the memory, when executed by the processor, causing the processor to implement the far-field speech awaking method provided in embodiments of the present disclosure.

The terminal device may be a smart speaker, a smart household (for example, a smart TV, a smart washer or a smart refrigerator), a smart car, or the like. Embodiments of the present disclosure do not limit specific form of the above described terminal device.

FIG. 5 is a schematic diagram illustrating a terminal device 12 suitable for realizing implementations of the present disclosure. The terminal device 12 illustrated in FIG. 5 is merely an exemplary, which should be not understood to limit the functions and usage scope of embodiments of the present disclosure.

As illustrated in FIG. 5, the terminal device 12 may be represented via a general computer device form. Components of the terminal device 12 may include but be not limited to one or more processors or processing units 16, a system memory 28, and a bus 18 connecting various system components including the system memory 28 and the processing units 16.

The bus 18 represents one or more of several types of bus structures, including a memory bus or a memory controller, a peripheral bus, a graphics acceleration port, a processor, or a local bus using any of a variety of bus structures. For example, these architectures include, but are not limited to, an Industry Standard Architecture (hereinafter referred to as ISA) bus, a Micro Channel Architecture (hereinafter referred to as MAC) bus, an enhanced ISA bus, a Video Electronics Standards Association (hereinafter referred to as VESA) local bus and Peripheral Component Interconnection (PCI) bus.

The terminal device 12 typically includes a variety of computer system readable media. These media may be any available media accessible by the terminal device 12 and includes both volatile and non-volatile media, removable and non-removable media.

The system memory 28 may include a computer system readable medium in the form of volatile memory, such as a random access memory (hereinafter referred to as RAM) 30 and/or a high speed cache memory 32. The terminal device 12 may further include other removable or non-removable, volatile or non-volatile computer system storage media. By way of example only, the storage system 34 may be configured to read and write a non-removable and non-volatile magnetic media (not shown in FIG. 5, commonly referred to as a “hard drive”). Although not shown in FIG. 5, a magnetic disk driver for reading from and writing to a removable and non-volatile magnetic disk (such as “floppy disk”) and a disk driver for a removable and non-volatile optical disk (such as compact disk read only memory (hereinafter referred to as CD-ROM), Digital Video Disc Read Only Memory (hereinafter referred to as DVD-ROM) or other optical media) may be provided. In these cases, each driver may be connected to the bus 18 via one or more data medium interfaces. The memory 28 may include at least one program product. The program product has a set (such as, at least one) of program modules configured to perform the functions of various embodiments of the present disclosure.

A program/utility 40 having a set (at least one) of the program modules 42 may be stored in, for example, the memory 28. The program modules 42 include but are not limited to, an operating system, one or more application programs, other programs modules, and program data. Each of these examples, or some combination thereof, may include an implementation of a network environment. The program modules 42 generally perform the functions and/or methods in the embodiments described herein.

The terminal device 12 may also communicate with one or more external devices 14 (such as, a keyboard, a pointing device, a display 24, etc.). Furthermore, the terminal device 12 may also communicate with one or more communication devices enabling a user to interact with the terminal device 12 and/or other devices (such as a network card, modem, etc.) enabling the terminal device 12 to communicate with one or more computer devices. This communication can be performed via the input/output (I/O) interface 22. Also, the terminal device 12 may communicate with one or more networks (such as a local area network (hereafter referred to as LAN), a wide area network (hereafter referred to as WAN) and/or a public network such as an Internet) through a network adapter 20. As shown in FIG. 5, the network adapter 20 communicates with other modules of the terminal device 12 over the bus 18. It should be understood that, although not shown in FIG. 5, other hardware and/or software modules may be used in connection with the terminal device 12. The hardware and/or software includes, but is not limited to, microcode, device drivers, redundant processing units, external disk drive arrays, RAID systems, tap Drive and data backup storage system.

The processing unit 16 is configured to execute various functional applications and data processing by running programs stored in the system memory 28, for example, implementing the far-field speech awaking method provided in embodiments of the present disclosure.

The present disclosure further provides a non-transitory computer readable storage medium, having a computer program thereon. The computer program is configured to implement the far-field speech awaking method provided in embodiments of the present disclosure.

The storage medium may adopt any combination of one or more computer readable media. The computer readable medium may be a computer readable signal medium or a computer readable storage medium. The computer readable storage medium may be, but is not limited to, for example, an electrical, magnetic, optical, electromagnetic, infrared, or semiconductor system, apparatus, device, component or any combination thereof. A specific example of the computer readable storage media include (a non-exhaustive list): an electrical connection having one or more wires, a portable computer disk, a hard disk, a random access memory (RAM), a read only memory (ROM), an Erasable Programmable Read Only Memory (EPROM) or a flash memory, an optical fiber, a compact disc read-only memory (CD-ROM), an optical memory component, a magnetic memory component, or any suitable combination thereof. In context, the computer readable storage medium may be any tangible medium including or storing programs. The programs may be used by an instruction executed system, apparatus or device, or a connection thereof.

The computer readable signal medium may include a data signal propagating in baseband or as part of a carrier which carries computer readable program codes. Such propagated data signal may be in many forms, including but not limited to an electromagnetic signal, an optical signal, or any suitable combination thereof. The computer readable signal medium may also be any computer readable medium other than the computer readable storage medium, which may send, propagate, or transport programs used by an instruction executed system, apparatus or device, or a connection thereof.

The program code stored on the computer readable medium may be transmitted using any appropriate medium, including but not limited to wireless, wireline, optical fiber cable, RF, or any suitable combination thereof.

The computer program code for carrying out operations of embodiments of the present disclosure may be written in one or more programming languages. The programming language includes an object oriented programming language, such as Java, Smalltalk, C++, as well as conventional procedural programming language, such as “C” language or similar programming language. The program code may be executed entirely on a user's computer, partly on the user's computer, as a separate software package, partly on the user's computer, partly on a remote computer, or entirely on the remote computer or server. In a case of the remote computer, the remote computer may be connected to the user's computer or an external computer (such as using an Internet service provider to connect over the Internet) through any kind of network, including a Local Area Network (hereafter referred as to LAN) or a Wide Area Network (hereafter referred as to WAN).

Reference throughout this specification to “one embodiment”, “some embodiments,” “an example”, “a specific example,” or “some examples,” means that a particular feature, structure, material, or characteristic described in connection with the embodiment or example is included in at least one embodiment or example of the present disclosure. In this specification, the appearances of the phrases in various places throughout this specification are not necessarily referring to the same embodiment or example of the present disclosure. Furthermore, the particular features, structures, materials, or characteristics may be combined in any suitable manner in one or more embodiments or examples. In addition, in a case without contradictions, different embodiments or examples or features of different embodiments or examples may be combined by those skilled in the art.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, like two or three, unless specified otherwise.

It will be understood that, the flow chart or any process or method described herein in other manners may represent a module, segment, or portion of code that comprises one or more executable instructions to implement the specified logic function(s) or that comprises one or more executable instructions of the steps of the progress. And the scope of a preferred embodiment of the present disclosure includes other implementations in which the order of execution may differ from that which is depicted in the flow chart, which should be understood by those skilled in the art.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

It can be understood that all or part of the steps in the method of the above embodiments can be implemented by instructing related hardware via programs, the program may be stored in a computer readable storage medium, and the program includes one step or combinations of the steps of the method when the program is executed.

In addition, each functional unit in the present disclosure may be integrated in one progressing module, or each functional unit exists as an independent unit, or two or more functional units may be integrated in one module. The integrated module can be embodied in hardware, or software. If the integrated module is embodied in software and sold or used as an independent product, it can be stored in the computer readable storage medium.

The computer readable storage medium may be, but is not limited to, read-only memories, magnetic disks, or optical disks.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A far-field speech awaking method, comprising:
under a far-field speech awaking state, detecting a sound signal obtained by a microphone array;
when an awaking word is detected in the sound signal, sending the sound signal to an online speech awaking engine;
receiving confirmation information sent from the online speech awaking engine, wherein the confirmation information is sent after the online speech awaking engine identifies the awaking word in the sound signal; and
starting a speech assistant to perform speech recognition.

2. The method according to claim 1, after sending the sound signal to the online speech awaking engine, further comprising:
receiving error information sent from the online speech awaking engine, wherein the error information is sent after the online speech awaking engine fails to identify the awaking word in the sound signal;
returning to perform detecting the sound signal obtained by the microphone array.

3. The method according to claim 1, wherein detecting the sound signal obtained by the microphone array comprises:
performing echo cancellation and denoising processing on a sound signal picked up by the microphone array to obtain a processed sound signal;
detecting the processed sound signal.

4. A far-field speech awaking device, comprising:
one or more processors,
a memory,
one or more software modules, stored in the memory, executable by the one or more processors, and comprising:
a detection module, configured to, under a far-field speech awaking state, detect a sound signal obtained by a microphone array;
a sending module, configured to send the sound signal to an online speech awaking engine when the detection module detects an awaking word in the sound signal;
a receiving module, configured to receive confirmation information sent from the online speech awaking engine, wherein the confirmation information is sent after the online speech awaking engine identifies the awaking word in the sound signal; and
a starting module, configured to start a speech assistant to perform speech recognition.

5. The device according to claim 4, wherein,
the receiving module is further configured to receive error information sent from the online speech awaking engine after the sending module sends the sound signal to the online speech awaking engine, wherein the error information is sent after the online speech awaking engine fails to identify the awaking word in the sound signal.

6. The device according to claim 4, wherein the detection module is configured to perform echo cancellation and denoising processing on a sound signal picked up by the microphone array to obtain a processed sound signal, and to detect the processed sound signal.

7. A non-transitory computer readable storage medium, having computer programs thereon, wherein the computer programs are configured to implement a far-field speech awaking method when executed by a processor, the method comprises:
under a far-field speech awaking state, detecting a sound signal obtained by a microphone array;
when an awaking word is detected in the sound signal, sending the sound signal to an online speech awaking engine;
receiving confirmation information sent from the online speech awaking engine, wherein the confirmation information is sent after the online speech awaking engine identifies the awaking word in the sound signal; and
starting a speech assistant to perform speech recognition.

8. The storage medium according to claim 7, after sending the sound signal to the online speech awaking engine, the method further comprising:
receiving error information sent from the online speech awaking engine, wherein the error information is sent after the online speech awaking engine fails to identify the awaking word in the sound signal;
returning to perform detecting the sound signal obtained by the microphone array.

9. The storage medium according to claim 7, wherein detecting the sound signal obtained by the microphone array comprises:
performing echo cancellation and denoising processing on a sound signal picked up by the microphone array to obtain a processed sound signal;
detecting the processed sound signal.
